(19) United States
(12) Patent Application Publication
(10) Pub. No.: US 2011/0233885 A1
(43) Pub. Date: Sep. 29, 2011

(54) LEAN-STEERING STABILIZATION DEVICE FOR A VEHICLE HAVING A LEANING PART AND A NON-LEANING PART

(75) Inventor: David Albert McMillan, San Jose, CA (US)

(73) Assignee: GRABTOWN, INC., Palo Alto, CA (US)

(21) Appl. No.: 13/069,156

(22) Filed: Mar. 22, 2011

Related U.S. Application Data
(60) Provisional application No. 61/316,598, filed on Mar. 23, 2010.

(51) Int. Cl. B62D 7/22

(52) U.S. Cl. 280/89.11

(57) ABSTRACT

A lean-steering stabilization device includes: a first hollow member; a second hollow member; a shaft extending into the first and second hollow members and secured to the second hollow member; a cam mechanism including a cam and a cam follower, the cam being provided on the second hollow member, the cam follower being provided on the first hollow member, the cam engaging the cam follower such that rotation of the cam relative to the cam follower about an axis results in movement of the cam relative to the cam follower along the axis; and a biasing member biased against the first hollow member and the shaft.

### CROSS-REFERENCE TO RELATED APPLICATION

This application claims priority of U.S. Provisional Application No. 61/316,598, filed on Mar. 23, 2010.

### BACKGROUND OF THE INVENTION

1. Field of the Invention

This invention relates to a lean-steering stabilization device for a vehicle having a leaning part and a non-leaning part.

2. Description of the Related Art

Conventional self-propelled or motorized lean-steer vehicles normally include a main frame connected to a wheel assembly through a pivot connection. The location of the pivot connection between the main frame and the wheel assembly has a significant effect on lean-steering of the main frame. The higher the location of the pivot connection, the greater will be the vehicle's resistance to tipping over during operation. In other words, a user's stability will be greater while riding on the vehicle. However, a higher pivot connection may also correspond to lower steering responsiveness. Providing a height-adjustable pivot connection to meet a broad range of user skill levels is mechanically complicated and expensive.

U.S. Pat. No. 5,630,774 discloses a conventional three-wheeled exercise vehicle that includes a front wheel assembly, a rear wheel assembly, a main frame disposed between the front and rear wheel assembly and connected to the rear wheel assembly, a pedal-striding drive assembly connected to the main frame, and a pivot connection. The main frame has an upright vertical section that is pivotally mounted to the front wheel assembly through the pivot connection. The pivot connection permits lean-steering of the upright vertical section of the main frame, and includes a pivot pin extending through a pivot axle housing of the front wheel assembly. The pivot axle housing is provided with an elastomeric block therein. A metal tube extends through the elastomeric block and is formed with a keyway. The pivot pin is formed with a key that engages the keyway so that when the upright vertical section of the main frame is inclined from an upright position to an inclined angle to rotate the pivot pin, the elastomeric block is pressed by the key and is gradually deformed to provide a resistive force against the leaning force exerted on the upright vertical section of the main frame. When the leaning operation is released, the elastomeric block restores the upright vertical section of the main frame to the upright position. The elastomeric block is designed to permit pivoting of no more than thirty degrees on either side of the upright vertical section of the main frame.

The aforesaid conventional three-wheeled exercise vehicle is disadvantageous. For example, when a user attempts to mount the conventional lean-steer vehicle, the weight of the user may cause the conventional lean-steer vehicle to lean, making it difficult to complete the mounting of the vehicle. In addition, the elastomeric block tends to deteriorate over time, and the resistive force of the elastomeric block against the leaning force cannot be adjusted.

### SUMMARY OF THE INVENTION

Therefore, an object of the present invention is to provide a lean-steering stabilization device for a vehicle that can overcome the aforesaid drawbacks associated with the prior art.

According to the present invention, there is provided a lean-steering stabilization device for a vehicle having a leaning part and a non-leaning part. The lean-steering stabilization device comprises: a first hollow member adapted to be connected to the non-leaning part of the vehicle and having a first open end; a second hollow member adapted to be connected to the leaning part of the vehicle and having an open end disposed adjacent to the first open end of the first hollow member; a shaft coaxially disposed with and extending into the first and second hollow members and secured to the second hollow member to permit rotation of the second hollow member together with the shaft relative to the first hollow member about an axis of the shaft; a cam mechanism including a cam and a cam follower, the earn being provided on the open end of the second hollow member to be co-movable with the second hollow member and the shaft, the cam follower being provided on the first open end of the first hollow member to be co-movable with the first hollow member, the cam engaging the cam follower such that rotation of the cam relative to the cam follower about the axis between a first angular position and a second angular position results in movement of the cam relative to the cam follower along the axis between first and second axial positions; and a biasing member biased against the first hollow member and the shaft to bias the cam in a manner to restore the cam from the second angular position to the first angular position and from the second axial position to the first axial position.

### BRIEF DESCRIPTION OF THE DRAWINGS

In drawings which illustrate an embodiment of the invention,

FIG. 1 is a perspective view of a vehicle including the preferred embodiment of a lean-steering stabilization device according to the present invention;

FIG. 2 is a partly sectional view of the preferred embodiment on the vehicle of FIG. 1;

FIG. 3 is an exploded perspective view of the preferred embodiment;

FIG. 4 is a sectional view of the preferred embodiment;

FIG. 5 is a schematic view of the preferred embodiment illustrating a state in which a cam is disposed at a first angular position relative to a cam follower;

FIG. 6 is a schematic view of the preferred embodiment illustrating another state in which the cam is disposed at a second angular position relative to the cam follower; and

FIG. 7 is a perspective view of the vehicle of FIG. 1 when an upright steering member is disposed at an inclined position.

### DETAILED DESCRIPTION OF THE PREFERRED EMBODIMENT

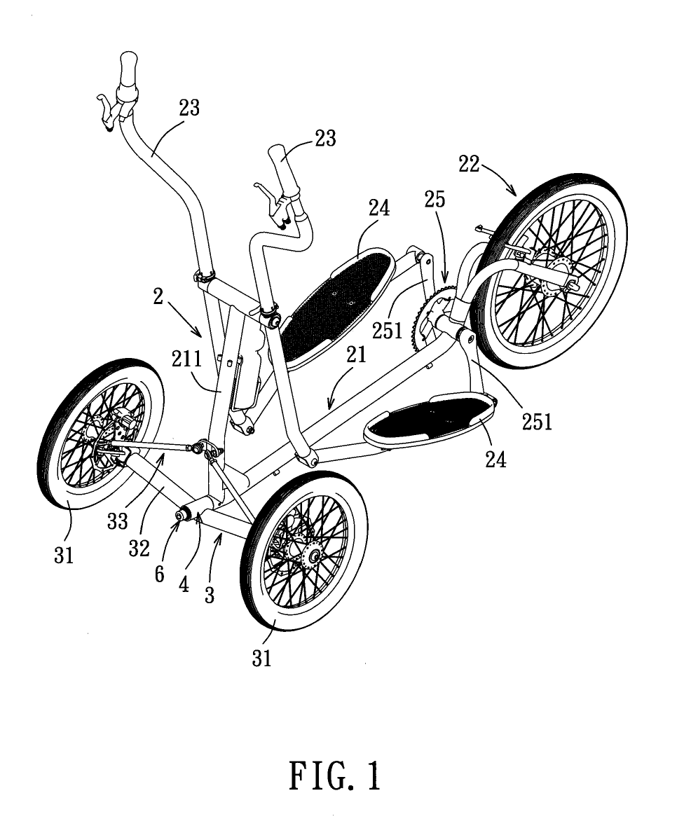

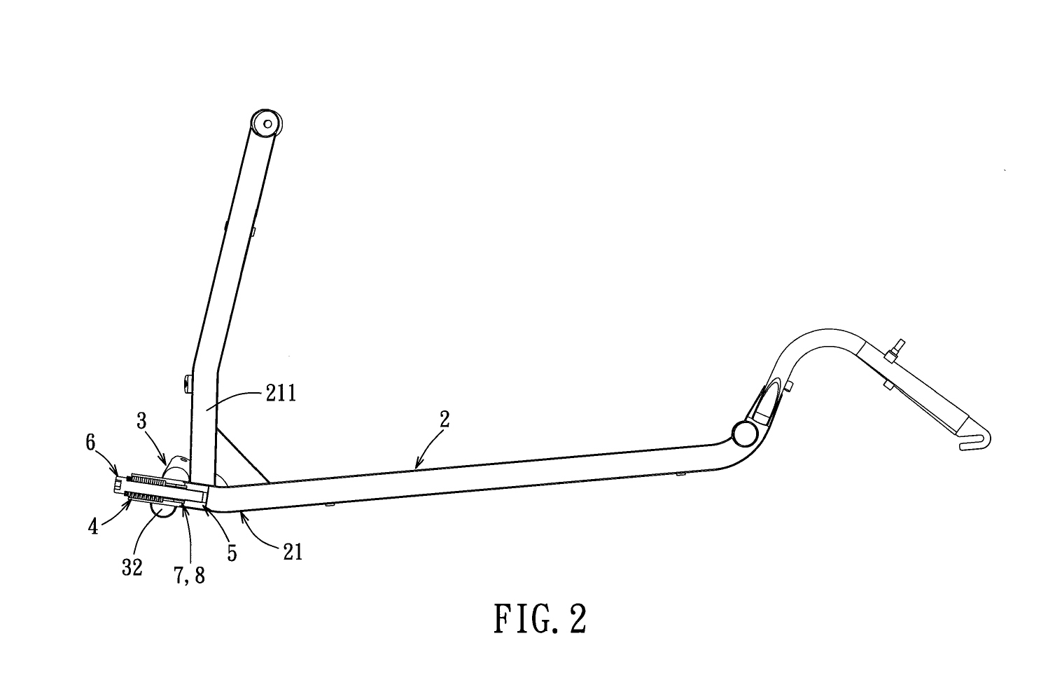

FIGS. 1 to 4 illustrate the preferred embodiment of a lean-steering stabilization device for a vehicle having a leaning part 2 and a non-leaning part 3 according to the present invention. The leaning part 2 includes a main frame 21 having an upright steering member 211, a rear wheel assembly 22 connected to the main frame 21, left and right poles 23 connected to the upright steering member 211, left and right striding pedals 24 connected to the left and right poles 23, respectively, and a chain mechanism 25 connected to the rear wheel assembly 22 and having left and right cranks 251 connected to the left and right striding pedals 24, respectively. The non-leaning part 3 includes two front wheels 31, an axle cross member 32 connected to the front wheels 31, and a wheel-controlling mechanism 33 connected to the upright steering member 211 and the front wheels 31 for controlling directions of the front wheels 31.

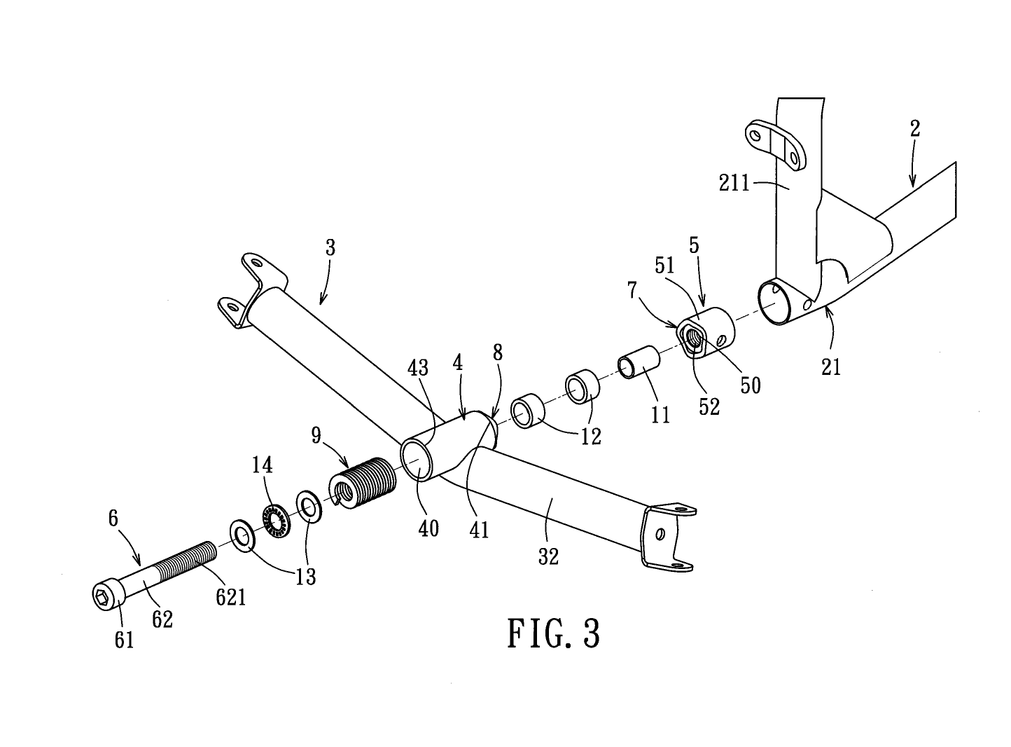

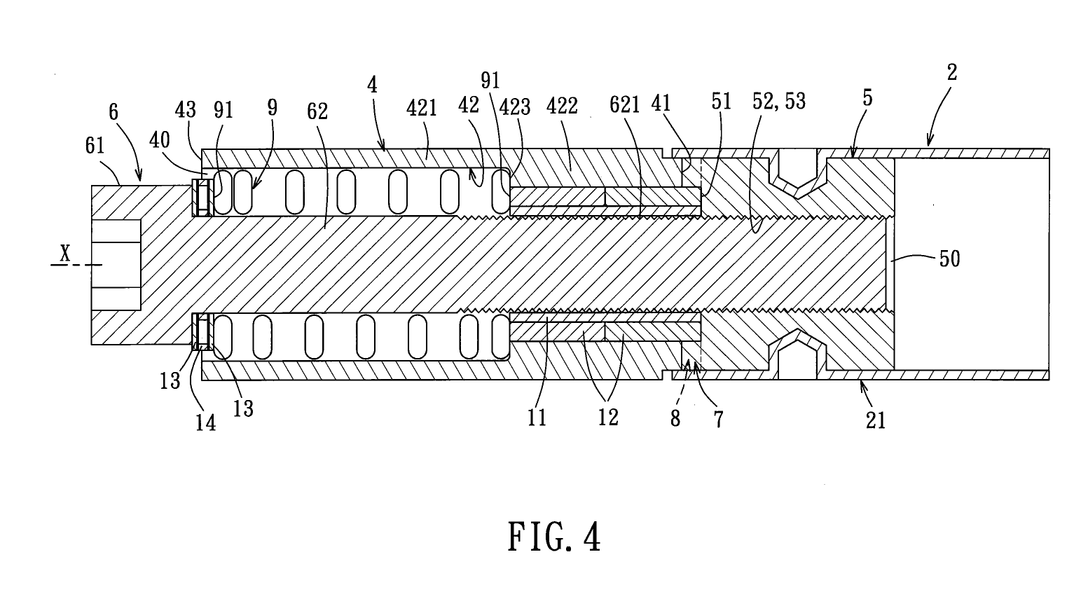

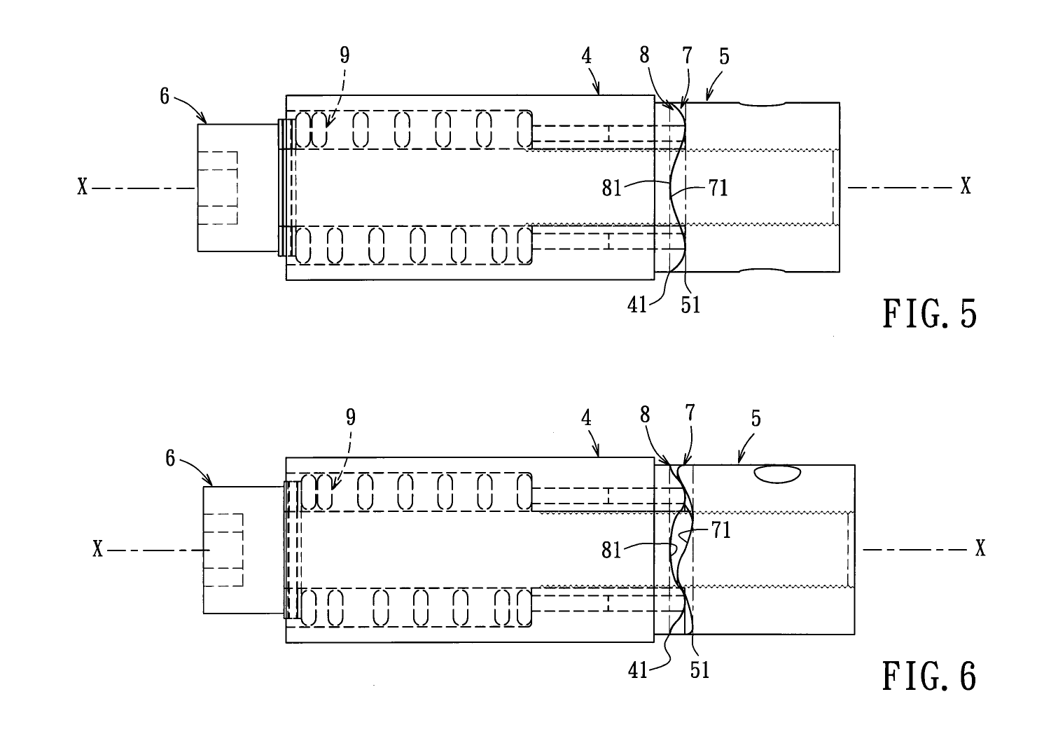

Referring to FIGS. 3 and 4, in combination with FIG. 1, the lean-steering stabilization device includes: a first hollow member 4 connected to the axle cross member 32 of the non-leaning part 3, extending in an axial direction, defining a first inner space 40, and having a first open end 41; a second hollow member 5 connected to the main frame 21 of the leaning part 2 of the vehicle, extending in the axial direction, defining a second inner space 50, and having an open end 51 disposed adjacent to the first open end 41 of the first hollow member 4; a shaft 6 coaxially disposed with the first and second hollow members 4, 5, extending in the axial direction into the first and second inner spaces 40, 50 and through the first open end 41 of the first hollow member 4 and the open end 51 of the second hollow member 5, and secured to the second hollow member 5 to permit rotation of the second hollow member 5 together with the shaft 6 relative to the first hollow member 4 about an axis (X) of the shaft 6; a cam mechanism including a cam 7 and a cam follower 8, the cam 7 being provided on the open end 51 of the second hollow member 5 to be co-movable with the second hollow member 5 and the shaft 6, the cam follower 8 being provided on the first open end 41 of the first hollow member 4 to be co-movable with the first hollow member 4, the cam 7 engaging the cam follower 6 such that rotation of the cam 7 relative to the cam follower 8 about the axis (X) between a first angular position (see FIG. 5) and a second angular position (see FIG. 6) results in movement of the cam 7 relative to the cam follower 8 along the axis (X) between first and second axial positions (see FIGS. 5 and 6); and a biasing member 9 inserted into the first inner space 40 and biased against the first hollow member 4 and the shaft 6 to bias the cam 7 through the shaft 6 and the second hollow member 5 in a manner to bias the cam 7 and the cam follower 8 from the second angular position to the first angular position and from the second axial position to the first axial position.

The cam 7 has a wavy first cam face 71 extending around the axis (X). The cam follower 8 has a wavy second cam face 81 extending around the axis (X). In this embodiment, the second cam face 81 fully matches the first cam face 71 when the cam 7 is disposed at the first angular position (see FIG. 5), and partially matches the first cam face 71 when the cam 7 is disposed at the second angular position (see FIG. 6). Alternatively, the extent of matching between the first and second cam faces 71, 81 at the first and second angular positions can be varied as required. Preferably, the first and second cam faces 71, 81 have a sinusoidal shape, the effect of which can achieve a more gradual change in the resistance to steering operation and a smoother feel. The resistance dynamics and the feel can be altered by varying the shapes and the amplitudes of the first and second cam faces 71, 81 as required.

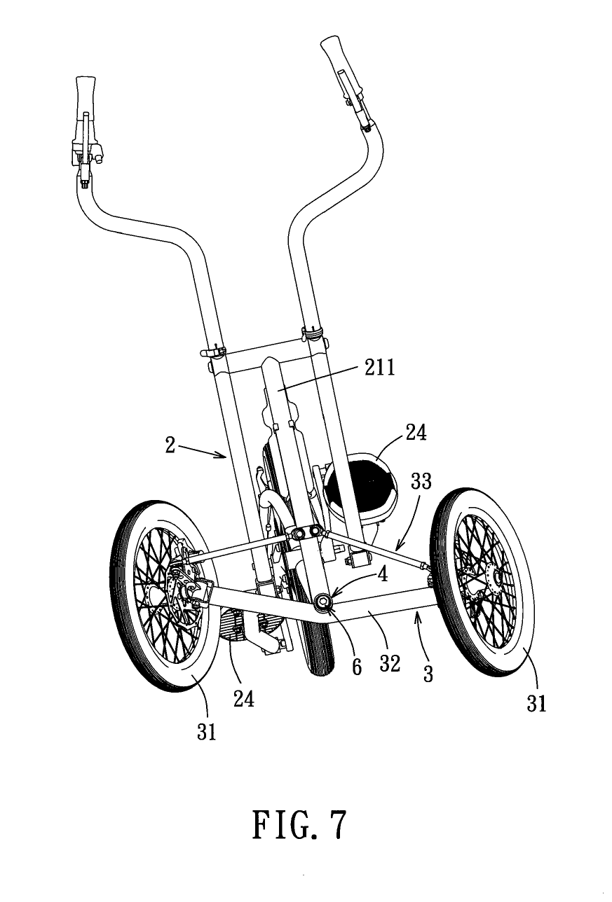

The upright steering member 211 is connected to the second hollow member 5 (see FIG. 4) such that the second hallow member 5 is co-rotatable with the upright steering member 211. The upright steering member 211 is operable between an upright position and an inclined position. When the upright steering member 211 is disposed at the upright position (see FIG. 1), the cam 7 is disposed at the first angular position. When the upright steering member 2 is moved to the inclined position (see FIG. 7), the cam 7 is moved to the second angular position.

The first hollow member 4 further has a cylindrical inner wall 42 defining the first inner space 40 and having a first segment 421 and a second segment 422. The inner diameter of the second segment 422 is smaller than that of the first segment 421. The first and second segments 421, 422 cooperatively define a shoulder 423 therebetween. The shaft 6 has a head portion 61 and a rod portion 62. The diameter of the rod portion 62 is smaller than that of the head portion 61. The biasing member 9 is disposed around the rod portion 62 and has two opposite ends 91 biased against the head portion 61 and the shoulder 423, respectively.

The first hollow member 4 further has a second open end 43 opposite to the first open end 41 along the axis (X). The first segment 421 extends from the shoulder 423 to the second open end 43. The biasing member 9 is in the form of a coil spring surrounding the rod portion 62 of the shaft 6 and extending between the shoulder 423 and the second open end 43. The head portion 61 of the shaft 6 is disposed adjacent to the second open end 43. The diameter of the head portion 61 is smaller than that of the first segment 421 of the cylindrical inner wall 42 of the first hollow member 4.

The second hallow member 5 has a cylindrical inner wall 52 defining the second inner space 50 and formed with an inner thread 53. The rod portion 62 of the shaft 6 is formed with an outer thread 621 that threadedly engages the inner thread 53. With this engaging design, the resistive force of the biasing member 9 against the leaning force exerted on the leaning part 2 of the vehicle can be adjusted. For instance, the biasing member 9 can be tightened to increase a larger resistive force opposing the leaning force to increase the stability of the vehicle during mounting or riding of the vehicle, such as for a novice user. On the other hand, the biasing member 9 can be loosened to increase steering responsiveness of the vehicle, such as for an experienced user.

The lean-steering stabilization device further includes a sleeve 11, two bearings 12, a pair of washers 13, and a bearing 14. The washers 13 and the bearing 14 collectively form a complete thrust bearing to prevent the shaft 6 from unthreading due to repeated inclination of the upright steering member 211 against the cross member 32. The sleeve 11 is disposed in the first inner space 40 and extends between the shoulder 423 of the cylindrical inner wall 42 of the first hollow member and the first open end 51 of the second hollow member 5. The sleeve 11 is sleeved on the rod portion 62 of the shaft 6. The bearings 12 are co-axially disposed between and in frictional contact with the second segment 422 of the cylindrical inner wall 42 of the first hollow member 4 and the sleeve 11. The washers 13 are disposed between and in contact with the head portion 61 of the shaft 6 and an adjacent one of the ends 91 of the biasing member 9. The bearing 14 is disposed between and in frictional contact with the washers 11.

With the inclusion of the cam mechanism, the shaft 6, and the biasing member 9 in the lean-steering stabilization device of this invention, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A lean-steering stabilization device for a vehicle having a leaning part and a non-leaning part, comprising:
a first hollow member adapted to be connected to the non-leaning part of the vehicle and having a first open end;
a second hollow member adapted to be connected to the leaning part of the vehicle and having an open end disposed adjacent to said first open end of said first hollow member;
a shaft coaxially disposed with and extending into said first and second hollow members, said shaft being secured to said second hollow member to permit rotation of said second hollow member together with said shaft relative to said first hollow member about an axis of said shaft;
a cam mechanism including a cam and a cam follower, said cam being provided on said open end of said second hollow member to be co-movable with said second hollow member and said shaft, said cam follower being provided on said first open end of said first hollow member to be co-movable with said first hollow member, said cam engaging said cam follower such that rotation of said cam relative to said cam follower about the axis between a first angular position and a second angular position results in movement of said cam relative to said cam follower along the axis between first and second axial positions; and
a biasing member biased against said first hollow member and said shaft to bias said cam in a manner to bias said cam from the second angular position to the first angular position and from the second axial position to the first axial position.

2. The lean-steering stabilization device of claim 1, wherein said first hollow member further has a cylindrical inner wall having a first segment and a second segment, said second segment having a diameter smaller than that of said first segment, said first and second segments cooperatively defining a shoulder therebetween, said shaft having a head portion and a rod portion, said rod portion having a diameter smaller than that of said head portion, said biasing member being disposed around said rod portion and having two opposite ends biased against said head portion and said shoulder, respectively.

3. The lean-steering stabilization device of claim 2, wherein said first hollow member further has a second open end opposite to said first open end along the axis, said first segment extending from said shoulder to said second open end, said biasing member being in the form of a coil spring surrounding said rod portion of said shaft and extending between said shoulder and said second open end, said head portion of said shaft being disposed adjacent to said second open end.

4. The lean-steering stabilization device of claim 2, further comprising a sleeve and at least one bearing, said sleeve being disposed in said first hollow member, extending between said shoulder of said cylindrical inner wall of said first hollow member and said first open end of said second hollow member, and sleeved on said rod portion of said shaft, said bearing being co-axially disposed between and in frictional contact with said second segment of said cylindrical inner wall of said first hollow member and said sleeve.

5. The lean-steering stabilization device of claim 2, further comprising two washers, and a bearing disposed between and in frictional contact with said washers, said washers being disposed between and in contact with said head portion of said shaft and a corresponding one of said ends of said biasing member.

6. The lean-steering stabilization device of claim 1, wherein said second hollow member has a cylindrical inner wall formed with an inner thread, said shaft having a rod portion formed with an outer thread that threadedly engages said inner thread.

7. The lean-steering stabilization device of claim 1, wherein said cam has a wavy first cam face extending around the axis, said cam follower having a wavy second cam face extending around the axis and matching said first cam face when said cam is disposed at the first angular position.
